(19) United States
(12) Patent Application Publication
(10) Pub. No.: US 2014/0061242 A1
(43) Pub. Date: Mar. 6, 2014

(54) GREASE GUN WITH AN OBSERVATION WINDOW

(71) Applicant: Sandra KUO, Taiping City (TW)

(72) Inventor: Sandra KUO, Taiping City (TW)

(21) Appl. No.: 13/602,137

(22) Filed: Sep. 1, 2012

(51) Int. Cl. B67D 7/56; G01F 11/00

(52) U.S. Cl. 222/156; 222/256

(57) ABSTRACT

A grease gun with an observation window is provided with a metal outer barrel, a plastic transparent inner barrel received in the outer barrel, and an operating end cover and a piston end cover screwed at two ends of the outer barrel. The observation window is formed on the outer barrel, and the two end covers define an oil storage space with respect to the inner barrel, and the interior of the oil storage space can be seen through the observation window of the outer barrel and the transparent inner barrel.

### BACKGROUND OF THE INVENTION

1. Field of the Invention

The present invention relates to a grease gun, and more particularly to a grease gun with an observation window.

2. Description of the Prior Art

FIG. 1 shows a conventional manually operated grease gun 10 which comprises a barrel 11 for storing grease, and a front end cover 12 and a rear end cover 13 screwed at two ends of the barrel 11. The front end cover 12 is provided with a dispensing tube 121 and a lever 122. A piston 14 is inserted through the rear end cover 13 and into the barrel 11 to push grease to the dispensing tube 121 by cooperating with the lever 122. However, the grease gun 10 is made of metal material, and therefore, the grease level inside the barrel 11 is totally invisible.

Therefore, another type of grease gun 100 with a transparent barrel 110 was invented as shown in FIG. 2, wherein the barrel 110 is made of transparent plastic material and includes a transparent barrel body 111 and a metal assembling member 112 at a rear end of the barrel body 111. A front end cover 12 is screwed with the front end of the transparent barrel body 111, and then the rear end cover 13 is screwed with the metal assembling member 112. The transparent barrel body 111 makes the grease level inside the barrel 110 viewable.

It is to be noted that the barrel body 111 of the plastic barrel 110 is preferably increased in thickness D in order to have a strong enough structural strength. However, the increased thickness D also increases the diameter of the barrel 110, it has to use the additional assembling member 112 to secure the rear end cover 13 to the barrel 110, which not only complicates the manufacturing process, but also increases the manufacturing cost. Moreover, screwing the metal made cover 12 and the assembling member 112 with the plastic made barrel 110 would have the problem that the plastic is likely to be worn out by the metal, causing leakage of grease.

The present invention has arisen to mitigate and/or obviate the afore-described disadvantages.

### SUMMARY OF THE INVENTION

The primary object of the present invention is to provide a grease gun with an observation window, wherein the grease gun not only has a strong structural strength, but also is able to allow the user to check the grease level through the observation window.

To achieve the above object, a grease gun with an observation window in accordance with the present invention comprises: an outer barrel, an inner barrel, an operating end cover and a piston end cover. The outer barrel is made of metal and includes a front open end and a rear open end, a direction extending from the front end to the rear open end is defined as a direction X, and the outer barrel is formed on the outer surface thereof with an observation window extending in the direction X. The inner barrel includes a transparent plastic barrel body with a first end and a second end and is received in the outer barrel in such a manner that the front and rear open ends of the outer barrel are aligned to the first and second ends of the inner barrel, respectively, and the barrel body of the inner barrel is viewable through the observation window of the outer barrel. The operating end cover is made of metal and provided with a front end cover, on the front end cover are provided a nozzle and a lever, the front end cover is screwed with the front open end of the outer barrel to abut the first end of the inner barrel. The piston end cover is made of metal and provided with a rear end cover and a piston inserted through the rear end cover. The rear end cover is screwed with the rear open end of the outer barrel to abut against the second end of the inner barrel. The front end cover and the rear end cover define an oil storage space with respect to the inner barrel, and interior of the oil storage space is viewable through the observation window of the outer barrel and the barrel body of the inner barrel.

### BRIEF DESCRIPTION OF THE DRAWINGS

FIG. 1 shows a conventional metal made grease gun;

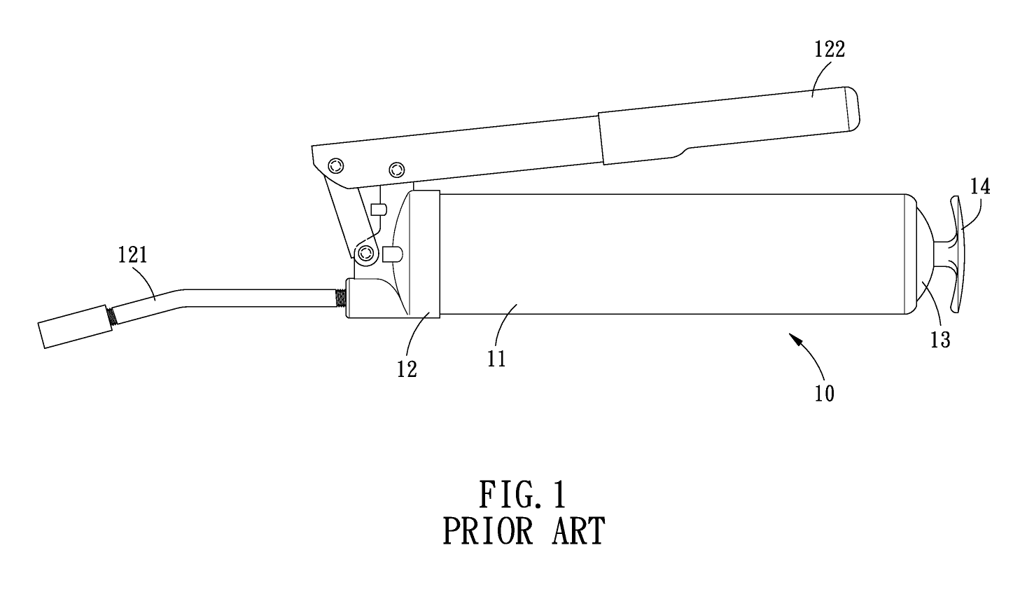

FIG. 2 shows a conventional plastic made grease gun;

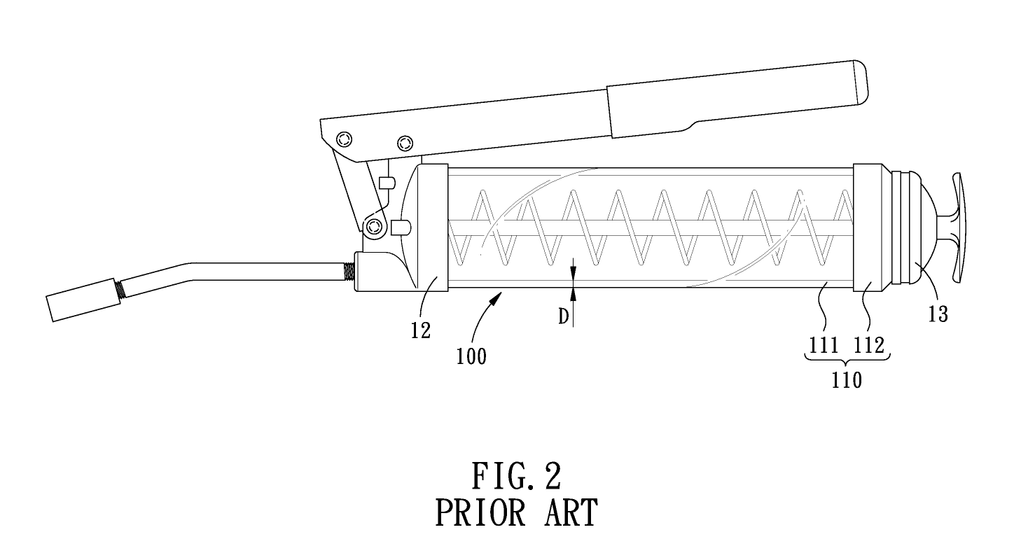

FIG. 3 is an exploded view of a grease gun with an observation window in accordance with the present invention;

FIG. 4 is an assembly view of the grease gun with an observation window in accordance with the present invention;

FIG. 5 is a perspective view showing that the grease gun with an observation window in accordance with the present invention is filled with grease; and

FIG. 6 is a perspective view showing that the grease gun with an observation window in accordance with the present invention is filled with grease bar.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

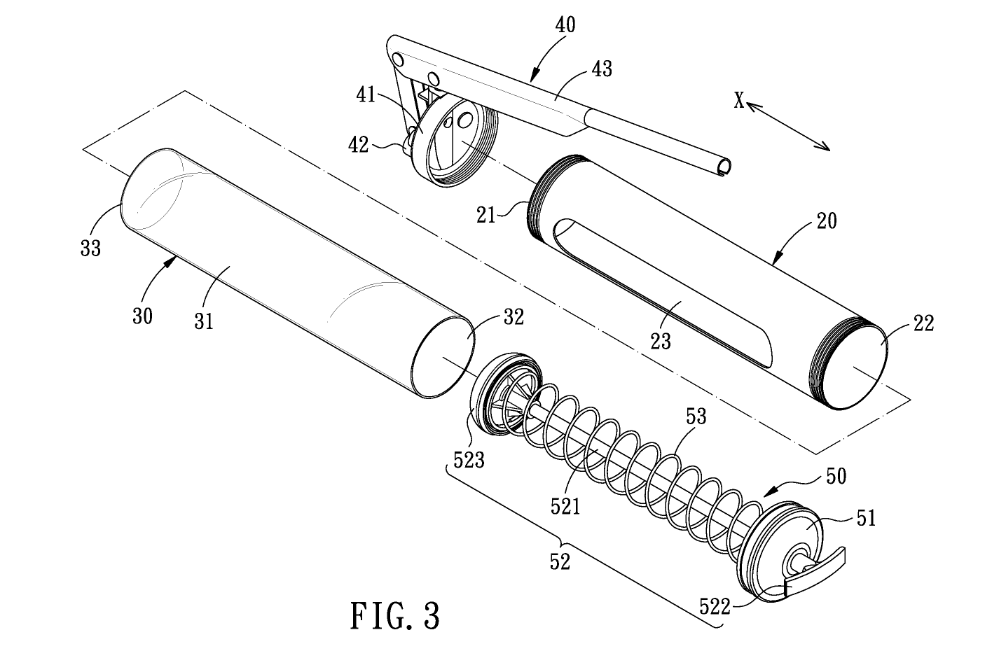

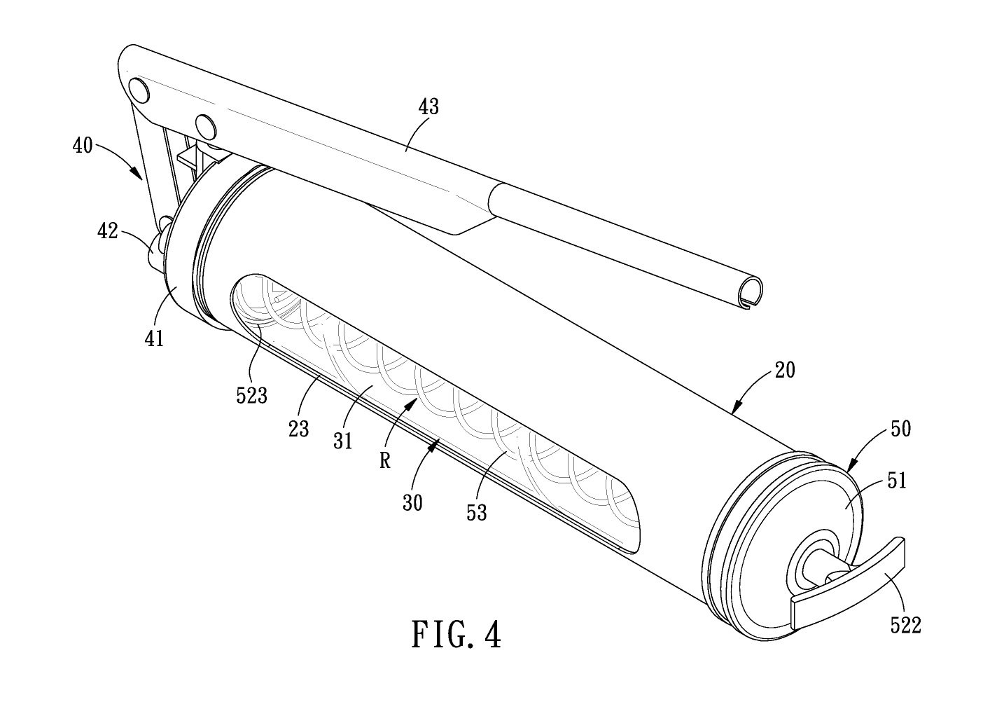

Referring to FIGS. 3-6, a grease gun with an observation window in accordance with a preferred embodiment of the present invention comprises: a metal outer barrel 20, a plastic transparent inner barrel 30 received in the outer barrel 20, and an operating end cover 40 and a piston end cover 50 at two ends of the outer barrel 20.

The outer barrel 20 is provided with a front open end 21 and a rear open end 22, a direction extending from the front open end 21 to the rear open end 22 is defined as a direction X, and the outer barrel 20 is formed on the outer surface thereof with an observation window 23 extending in the direction X.

The inner barrel 30 includes a transparent plastic barrel body 31 with a first end 32 and a second end 33 and is received in the outer barrel 20 in such a manner that the front and rear open ends 21, 22 of the outer barrel 20 are aligned to the first and second ends 32, 33 of the inner barrel 30, respectively, and the barrel body 31 of the inner barrel 30 can be seen through the observation window 23 of the outer barrel 20.

The operating end cover 40 is made of metal and provided with a front end cover 41. On the front end cover 41 are provided a nozzle 42 and a lever 43. The front end cover 41 is screwed with the front open end 21 of the outer barrel 20 to abut against the first end 32 of the inner barrel 30. In this embodiment, grease is pushed out of the nozzle 42 by operating the lever 43, and the nozzle 42 and the lever 43 are conventional in the art, no further description will be given here.

The piston end cover 50 is made of metal and provided with a rear end cover 51 and a piston 52 inserted through the rear end cover 51. The rear end cover 51 is screwed with the rear open end 22 of the outer barrel 20 to abut against the second end 33 of the inner barrel 30. The front end cover 41 and the rear end cover 51 define an oil storage space R with respect to the inner barrel 30, and the interior of the oil storage space R can be seen through the observation window 23 of the outer barrel 20 and the barrel body 31 of the inner barrel 30.

In this embodiment, the piston 52 of the piston end cover 50 includes a rod portion 521, and a push handle 522 and a piston head 523 at both ends of the rod portion 521. A spiral spring 53 is sleeved on the rod portion 521 with two ends pushed against the rear end cover 51 and the piston head 523 respectively, and the piston head 523 is received in the oil storage space R, so that, when the piston 52 moves in the direction X within the oil storage space R, the movement of the piston head 523 can be seen through the observation window 23 of the outer barrel 20 and the barrel body 31 of the inner barrel 30.

In this embodiment, each of the front and rear open ends 21, 22 of the outer barrel 20 is formed with an outer thread for screwing with an inner thread formed on each of the front and rear end covers 41, 51, so that the front and rear end covers 41, 51 can be screwed at the front and rear open ends 21, 22 of the outer barrel 20, respectively.

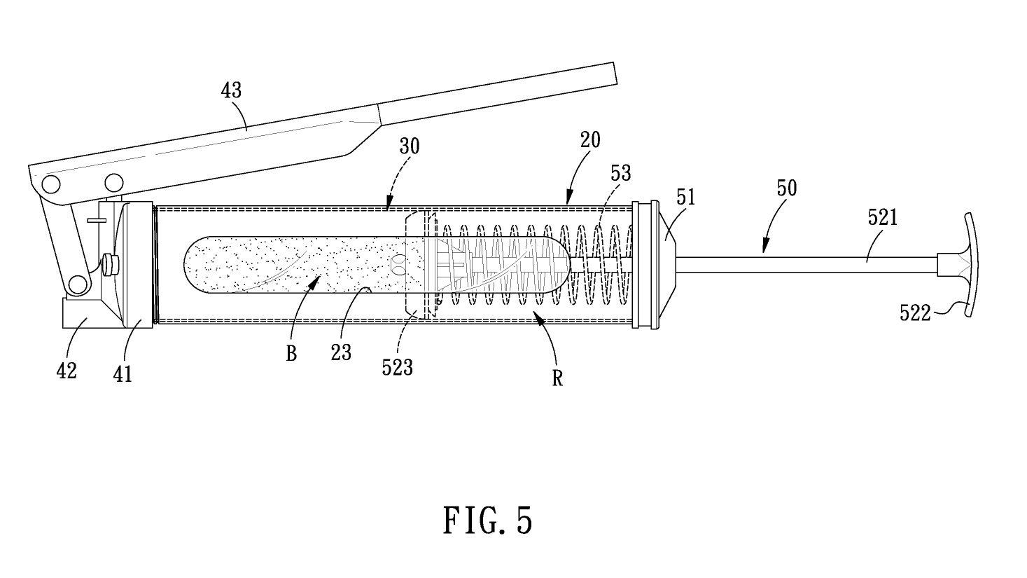

What mentioned above are the structural relations of the main parts of the present invention, for a better understanding of the function and operation of the grease gun with an observation window of the preferred embodiment of the present invention, reference should be made back to FIG. 5. The piston head 523 of the piston 52 is received in the oil storage space R, the grease B is stuffed between the piston head 523 and the front end cover 41, and the piston head 523 pushes the grease B toward the operating end cover 40. Through the observation window 23, the user knows how much grease B has been used and can see the movement of the piston 52 within the oil storage space R.

Since the outer barrel 20, and the front and rear end cover 41, 51 are made of metal, which solves the problem of the conventional grease gun that the plastic is likely to be worn out by the metal and consequently preventing leakage of grease. Furthermore, the outer barrel 20 of the grease gun of the present invention is made of metal, it doesn't need to increase the thickness of the outer barrel in order to improve structural strength, therefore, it doesn't have the problem the conventional grease gun that the barrel is increased in thickness and doesn't fit the end cover, and it has to use the additional assembling member to secure the rear cover to the barrel.

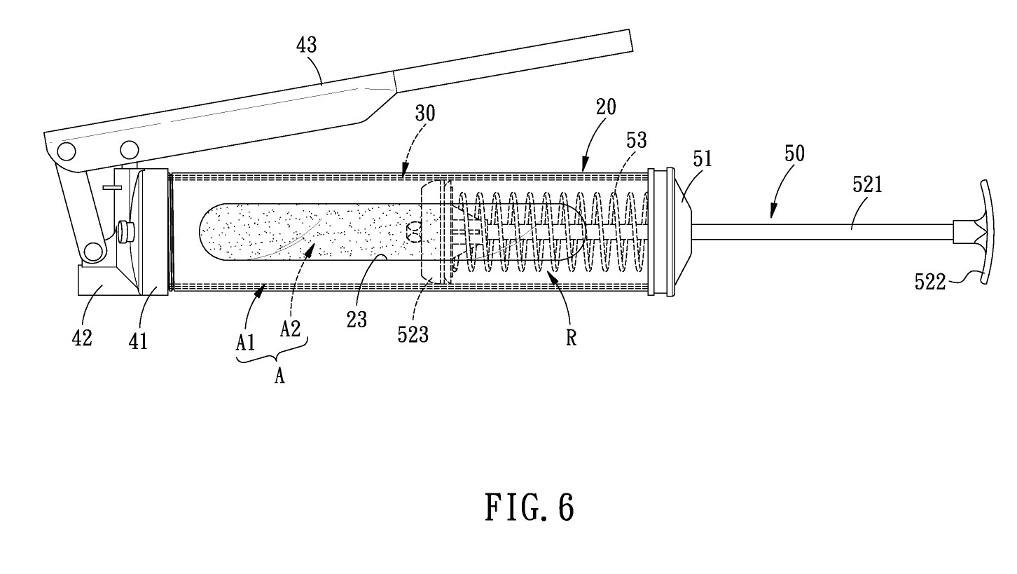

It is to be noted that, as shown in FIG. 6, in order to make it easy to fill the grease into the grease gun, a commercially available grease bar A which consists of a grease barrel A1 filled with grease A2, appeared on the market, and the grease barrel A1 and the grease A2 are simultaneously filled into the oil storage space R of the grease gun. As shown in FIG. 6, the piston head 523 of the piston 52 is received in the grease barrel A1 of the grease bar A to push the grease A2 out of the nozzle 42 of the operating end cover 40. Through the observation window 23, the user can see the commodity information (such as expire date, product name, logo, etc) on the grease barrel A1.

In general, the grease gun in accordance with the present invention is formed by the metal made outer barrel 20 with the observation window 23 and the transparent plastic inner barrel 30 received in the outer barrel 20, which only improves the structural strength of the grease barrel, the transparent inner barrel allows the user to see the grease level, the movement of the piston, or the product information printed on the grease bar.

While we have shown and described various embodiments in accordance with the present invention, it is clear to those skilled in the art that further embodiments may be made without departing from the scope of the present invention.

What is claimed is:

1. A grease gun with an observation window comprising:
an outer barrel made of metal and including a front open end and a rear open end, a direction extending from the front end to the rear open end being defined as a direction X, and the outer barrel being formed on the outer surface thereof with an observation window extending in the direction X;
an inner barrel including a transparent plastic barrel body with a first end and a second end and being received in the outer barrel in such a manner that the front and rear open ends of the outer barrel are aligned to the first and second ends of the inner barrel, respectively, and the barrel body of the inner barrel is viewable through the observation window of the outer barrel;
an operating end cover made of metal and provided with a front end cover, on the front end cover being provided a nozzle and a lever, the front end cover being screwed with the front open end of the outer barrel to abut the first end of the inner barrel; and
a piston end cover made of metal and provided with a rear end cover and a piston inserted through the rear end cover, the rear end cover being screwed with the rear open end of the outer barrel to abut against the second end of the inner barrel, the front end cover and the rear end cover define an oil storage space with respect to the inner barrel, and interior of the oil storage space is viewable through the observation window of the outer barrel and the barrel body of the inner barrel.

2. The grease gun with an observation window as claimed in claim 1, wherein the piston of the piston end cover includes a push handle at one end thereof and a piston head at another end thereof, the piston head is received in the oil storage space, so that, when the piston moves in the direction X within the oil storage space, the movement of the piston head will be viewable through the observation window of the outer barrel and the barrel body of the inner barrel.

3. The grease gun with an observation window as claimed in claim 1, wherein the piston of the piston end cover includes a rod portion, and a push handle and a piston head at two ends of the rod portion, a spiral spring is sleeved on the rod portion with two ends pushed against the rear end cover and the piston head respectively.

4. The grease gun with an observation window as claimed in claim 1, wherein the piston of the piston end cover includes a piston head at one thereof, a grease bar which consists of a grease barrel filled with grease, is filled into the oil storage space of the grease gun, the piston head of the piston is received in the grease barrel of the grease bar to push the grease out of the nozzle of the operating end cover, the grease bar is viewable through the observation window.

5. The grease gun with an observation window as claimed in claim 1, wherein the piston of the piston end cover includes a piston head at one thereof, and the piston head is received in the oil storage space, the grease is stuffed between the piston head and the front end cover, and the piston head pushes the grease toward the operating end cover.
